(19) United States
(12) Patent Application Publication
(10) Pub. No.: US 2015/0031428 A1
(43) Pub. Date: Jan. 29, 2015

(54) METHOD AND SERVER FOR PROVIDING GAME ITEM SERVICE, AND RECORDING MEDIUM

(71) Applicant: INTELLECTUAL DISCOVERY CO., LTD., Seoul (KR)

(72) Inventor: Sung Jin Ko, Seoul (KR)

(73) Assignee: INTELLECTUAL DISCOVERY CO., LTD., Seoul (KR)

(21) Appl. No.: 14/384,592

(22) PCT Filed: Dec. 20, 2012
(86) PCT No.: PCT/KR2012/011130

§ 371 Date: Sep. 11, 2014

(30) Foreign Application Priority Data
Apr. 20, 2012 (KR) 10-2012-0011267

(51) Int. Cl. A63F 13/69; A63F 13/35; A63F 13/792; H04L 12/24

(52) U.S. Cl. CPC A63F 13/69; H04L 41/50; A63F 13/35; A63F 13/792
USPC 463/11; 463/42; 463/25

(57) ABSTRACT

A method for providing a game item service in accordance with an embodiment of the present invention includes: receiving real issue data from the outside by a game server; and reflecting and applying the real issue data to an item.

### TECHNICAL FIELD

The present invention relates to a method and a server for providing a game item service and a recording method therefor, and more particularly, to a method and a server for providing a game item service and a recording method therefor, to provide users with game items in a packaged form.

### BACKGROUND ART

With development of network supply environments, services for providing various contents on the Internet have recently stepped out onto the stage. Among these services, services for providing game contents have been being experienced rapid growth in market expansion and supply speed.

Further, diffused demand for these game contents services causes a sharp rise in the development speed and supply speed of the game contents services. As the number of users who uses the game services has significantly increased, some free game services start to charge users for their use.

Such online-based game contents providing services are advantageous in enabling one user to play the same game with other users who are remote from the user without constraints of time and space.

As such, as the number of users who use game services through the Internet is sharply raised and charged game contents services are in progress, many portal sites and game service providers have developed various kinds of services to produce their profits.

When selling items to users on a game, the online game service providers are required to develop a new type of game service providing system beyond the conventional item selling system to create higher profits.

### DISCLOSURE

### Technical Problem

The present invention has been made in an effort to provide a method and a server for providing a game item service and a recording method therefor, having advantages of providing game items to users in consideration of information reflected with issues generated in the reality.

### Technical Solution

An exemplary embodiment of the present invention provides a game item service method including: by a game server, receiving real issue data related to a game that is provided by the game server, from the outside; and reflecting and applying the real issue data to an item.

The receiving may include receiving the real issue data by using information inputted from a manager who manages the game server.

The receiving may include receiving the real issue data by using information provided from a user terminal which accesses the game server to perform the game.

The applying may include applying the real issue data to a plurality of items and packaging the game items.

The packaging may include determining the number of items to be packaged to correspond to the real issue data by applying the real issue data and packaging the game items according to the determined number.

Another exemplary embodiment of the present invention provides a game item service method including: receiving real issue data related to a soccer game, from the outside; configuring player cards as an item having soccer player characters by reflecting the real issue data to the player cards and packaging the player cards; and providing the packaged player cards to be bought on the game by a game user.

The configuring may include applying real issue data to the player cards on the game and packaging the player cards.

The packaging may include determining the number of player cards to be packaged to correspond to the real issue data by applying the real issue data and packaging the player cards on the game according to the determined number.

Yet another exemplary embodiment of the present invention provides a game server including: a transceiving module configured to transmit and receive data including a game item to and from a user terminal; an issue managing module configured to manage real issue data related to a game provided by the game server, inputted from the outside; and an item managing module configured to reflect and apply the real issue data to the game item to manage the item.

The item managing module may include: an issue reflecting module configured to reflect and apply the real issue data provided from the issue managing module to the item to manage the item; and a packaging module configured to reflect the real issue data to a plurality of items and package the items.

The item managing module may include: an issue reflecting module configured to reflect and apply the real issue data provided from the issue managing module to the item to manage the item; and a packaging module configured to reflect the real issue data to a plurality of items and package the items.

The packaging module may determine the number of the player cards to be packaged to correspond to the real issue data by applying the real issue data and packages the player cards on the game according to the determined number.

The game server may further include a payment module configured to perform cost management of a payment for an item managed by the item managing module, when a request of the payment is received from the user terminal.

### Advantageous Effects

In accordance with the exemplary embodiments of the present invention, the method and the server for providing a game item service, and a recording medium therefor can enable a user to feel a sense of reality in a game by providing a game item in consideration of information reflected with an issue generated from the reality.

Further, the method and the server for providing a game item service, and a recording medium therefor can provide an effect of being capable of increasing an interest rate of the user in the game.

In addition, the method and the server for providing a game item service, and a recording medium therefor can provide an effect of facilitating improvement in sales of game items by continuously reflecting new issues generated in the reality.

### DESCRIPTION OF THE DRAWINGS

The objects and features of the present invention will become apparent from the following description of embodiments, given in conjunction with the accompanying drawings, in which:

FIG. 1 is a schematic diagram showing the structure of a game item service system in accordance with an exemplary embodiment of the present invention.

FIG. 2 shows a game server in accordance with the present exemplary embodiment.

FIG. 3 is a diagram for describing an item managing module shown in FIG. 2 in more detail.

FIG. 4 is a flowchart showing a game item service method in accordance with the present exemplary embodiment.

FIG. 5 is a flowchart for describing the game item service method in accordance with the present exemplary embodiment in more detail.

FIG. 6 shows a package set provided by packaging a player card in accordance with the present exemplary embodiment.

FIG. 7 shows player cards included in the package set in accordance with the present exemplary embodiment.

FIG. 8 and FIG. 9 show package sets reflected with information generated in the reality in accordance with other exemplary embodiments of the present invention.

### MODE FOR INVENTION

An exemplary embodiment of the present invention provides a game item service method including: by a game server, receiving real issue data related to a game that is provided by the game server, from the outside; and reflecting and applying the real issue data to an item.

The receiving may include receiving the real issue data by using information inputted from a manager who manages the game server.

The receiving may include receiving the real issue data by using information provided from a user terminal which accesses the game server to perform the game.

The applying may include applying the real issue data to a plurality of items and packaging the game items.

The packaging may include determining the number of items to be packaged to correspond to the real issue data by applying the real issue data and packaging the game items according to the determined number.

Another exemplary embodiment of the present invention provides a game item service method including: receiving real issue data related to a soccer game, from the outside; configuring player cards as an item having soccer player characters by reflecting the real issue data to the player cards and packaging the player cards; and providing the packaged player cards to be bought on the game by a game user.

The configuring may include applying real issue data to the player cards on the game and packaging the player cards.

The packaging may include determining the number of player cards to be packaged to correspond to the real issue data by applying the real issue data and packaging the player cards on the game according to the determined number.

Yet another exemplary embodiment of the present invention provides a game server including: a transceiving module configured to transmit and receive data including a game item to and from a user terminal; an issue managing module configured to manage real issue data related to a game provided by the game server, inputted from the outside; and an item managing module configured to reflect and apply the real issue data to the game item to manage the item.

The item managing module may include: an issue reflecting module configured to reflect and apply the real issue data provided from the issue managing module to the item to manage the item; and a packaging module configured to reflect the real issue data to a plurality of items and package the items.

The item managing module may include: an issue reflecting module configured to reflect and apply the real issue data provided from the issue managing module to the item to manage the item; and a packaging module configured to reflect the real issue data to a plurality of items and package the items.

The packaging module may determine the number of the player cards to be packaged to correspond to the real issue data by applying the real issue data and packages the player cards on the game according to the determined number.

The game server may further include a payment module configured to perform cost management of a payment for an item managed by the item managing module, when a request of the payment is received from the user terminal.

Hereinafter, exemplary embodiments of the present invention will be described in detail with reference to the accompanying drawings.

In the following description, in order to clearly understand the present invention, description of a known technology regarding a characteristic of the present invention will be omitted. It is obvious that the following exemplary embodiment is a detailed description which is provided for more understanding of the present invention but does not limit the scope of the present invention. Therefore, an equivalent invention which performs the same function as the present invention may be also covered by the scope of the present invention.

In the following description, like reference numerals designate like elements having the same configuration and redundant description and description of a known technology will be omitted.

In an exemplary embodiment of the present invention, “communication”, “communication network” and “network” may be used to have the same meaning. The three terminologies indicate a wired or wireless local area and wide area data transmitting/receiving network through which a file is transmitted/received between a user terminal, another user terminal, and a download server.

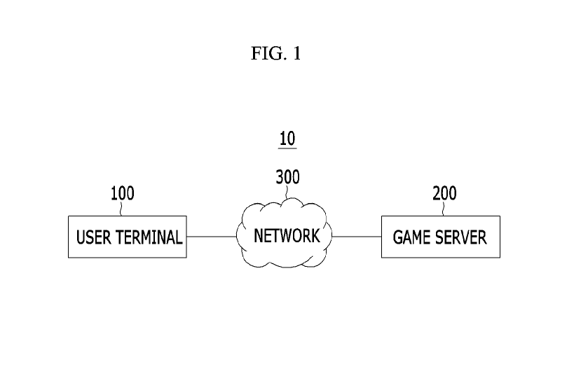

FIG. 1 is a schematic diagram showing the structure of a game item service system in accordance with an exemplary embodiment of the present invention.

The game item service system 10 includes a user terminal 100, and a game server 200 connected to the user terminal 100 through a network 300.

Referring to FIG. 1, the game server 200 which is connected to the user terminal 100 through the network 300 may provide a game (e.g., a soccer game) through the network 300 to the user terminal 100, and may sell/provide various items to a user of the user terminal 100 who plays the game.

Further, when the game server 200 sells/provides an item to the user terminal 100, the item may be an item reflected with an issue generated in the reality.

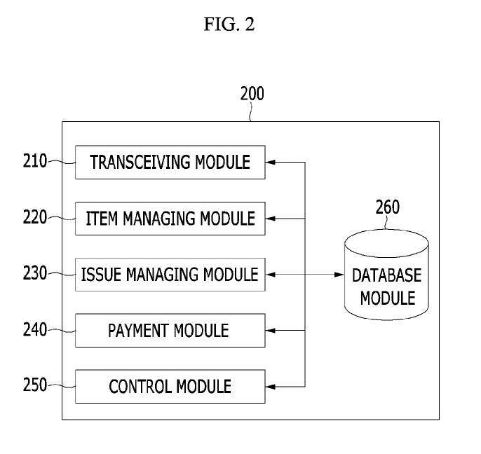

The game server 200 will be described later in more detail with reference to FIG. 2.

The user terminal 100 maintains an access state to the game server 200 through the network 300 such as Internet or a phone line. The user terminal 100 may include, e.g., a personal computer, a handheld computer a personal digital assistant (PDA), a mobile phone, a smart phone, or the like. Further, the user terminal 100 may correspond to a concept that collectively indicates a terminal including a microprocessor so as to have a computing power.

FIG. 2 shows a game server in accordance with the present exemplary embodiment. The game server 200 may include a transceiving module 210, an item managing module 220, an issue managing module 230, a payment module 240, a control module 250, and a database 260.

It shall be obvious to a person of an ordinary skill in the art pertaining to the present invention that terms used herein ‘server’ or ‘module’ indicate a logic constituent unit, but may not serve as an constituent element that is physically recognized.

Referring to FIG. 2, the transceiving module 210 serves to transmit and receive various data to and from the user terminal 100. For example, the transceiving module 210 210 serves to transmit and receive data related items of the game to and from the user terminal 100. In this case, the game may include a soccer game.

The item managing module 220 serves to manage game items. For example, when the game is the soccer game and a player card is taken as an example of a soccer game item, the item managing module 220 may manage the player card as an item having soccer player characters. Specifically, when the user terminal 100 holds or buys and holds the player card, the game server 200 may use the item managing module 220 to manage the player card as the item in such a way so as to perform the soccer game by using the soccer players included in the player card. In this case, the item managing module 220 may manage the player card in a package form.

The issue managing module 230 may manage issues related to the game among the issues generated in the reality. For example, in the case of selecting 11 best players in 2012 in the real soccer game as an issue, the issue may be managed by the issue managing module 230. In this case, information related to the issue may be inputted from a manager of the game server 200. The issue managing module 230 may provide the issue to the item managing module 220 such that an item package reflected with the issue or the like can be managed.

The payment module 240 serves to perform all managements for game cost. For example, when the user terminal 100 buys a game item, the payment module 240 may serve to manage the payment of the game item. When the user terminal 100 makes payment to buy a player card package of the soccer game, the payment may be managed by the payment module 24.

The database 260 may store all data for the game server 200 such as the game supported by the game server 200, data related to game items, information related to users accessing the game, and data related to payment.

The control module 250 serves to control the transceiving module 210, the item managing module 220, the issue managing module 230, the payment module 240, and the database 260 to respectively perform corresponding functions. For example, when receiving a payment request for the player card item from the user terminal 100, the control module 250 controls the payment module 240 to manage the payment and item managing module 220 to transmit the requested item to the user terminal 100 through the transceiving module 210.

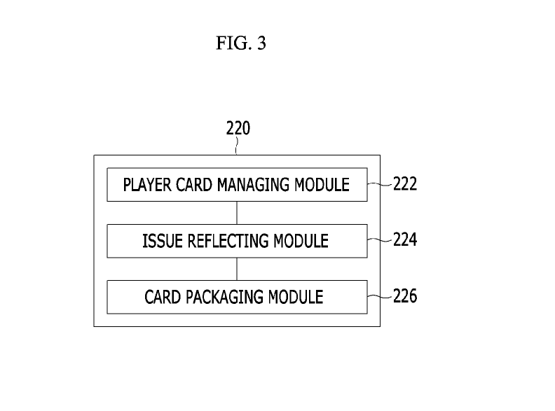

FIG. 3 is a diagram for describing an item managing module shown in FIG. 2 in more detail. The item managing module 220 includes a player card managing module 222, an issue reflecting module 224, and a card packaging module 226. The following description is made based on the soccer game which is provided to user terminal 100 to the game server 200 by referring to FIG. 3.

Referring to FIG. 3, the player card managing module 222 serves to manage a player card item as an item having soccer player characters. For example, when the game server 200 provides the soccer game to the user terminal 100, the player card item may be provided to the user terminal 100 or may be sold by the user terminal 100. Further, the player card managing module 222 may manage the player card item in a package from.

The issue reflecting module 224 may serve to reflect information related to an issue generated in the reality to the player card, and the player card reflected with this issue information may be managed by the player card managing module 222. In this case, the information related to the issue generated in the reality may be received from the outside (e.g., input by a manager).

The card packaging module 226 may serve to package the player card item. For example, the card packaging module 226 may package the player card item reflected with the issue information from the reality by the issue reflecting module 224. In this case, the player card managing module 222 manages the packaged player card item.

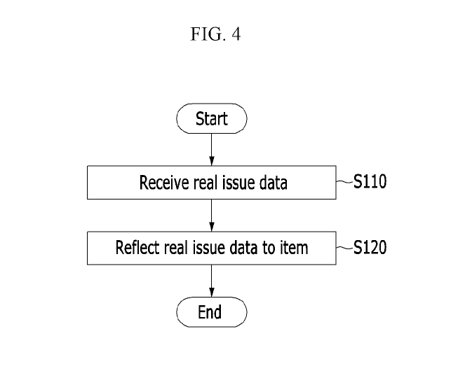

FIG. 4 is a flowchart showing a game item service method in accordance with the present exemplary embodiment. The game item service method may be performed by the game service system 10 shown in FIG. 10.

Referring to FIG. 4, the game server 200 receives real issue data from the outside (S110). In this case, the real issue data indicates data related to an issue about a game that is provided to the user terminal 100 by the game sever 200. For example, the real issue data may indicate data inputted from a manager of the game server 200, but the present exemplary embodiment is not limited thereto. Alternatively, the real issue data may indicate information data provided from the user terminal 100.

Next, the game server 200 may reflect the real issue data to a game item (S120). For example, contents of the real issue data are applied to the game item. Then, when the user terminal 100 uses the game item, the game may be performed by being reflected with the real issue data.

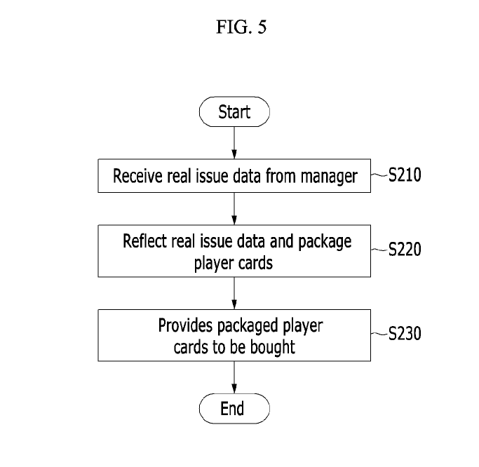

FIG. 5 is a flowchart for describing the game item service method in accordance with the present exemplary embodiment in more detail. The game item service method may be performed by the game service system 10 shown in FIG. 10.

Referring to FIG. 5, the game server 200 for providing a soccer game receives real issue data from the outside (S210). In this case, the real issue data indicates data related to an issue about a game that is provided to the user terminal 100 by the game sever 200. For example, the real issue data may indicate data inputted from a manager of the game server 200, but the present exemplary embodiment is not limited thereto. Alternatively, the real issue data may indicate information data (e.g., information related to a real issue) provided from the user terminal 100.

Next, the game server 200 reflects the real issue data to a player card item as an item having soccer player characters and packages the player card item reflected with the real issue data (S220). In this case, the game server 200 may determine the number of player cards to be packaged to correspond to the real issue by applying the real issue data thereto, and package the player cards according to the determined number of the player cards on the game.

Then, the game server 200 may provide the packaged player cards such that a game user of the user terminal 100 can buy them on the game (S230). For example, in the case of the soccer game, the packaged player cards may correspond to FIFA 11 best players in a specific year, Best Top scorers in a specific year, 11 best players in a specific league, or the like. The above description is merely an example, and the player cards may be packaged by reflecting various real issues (e.g., according to ability values, nationalities, prize achievements, or the like).

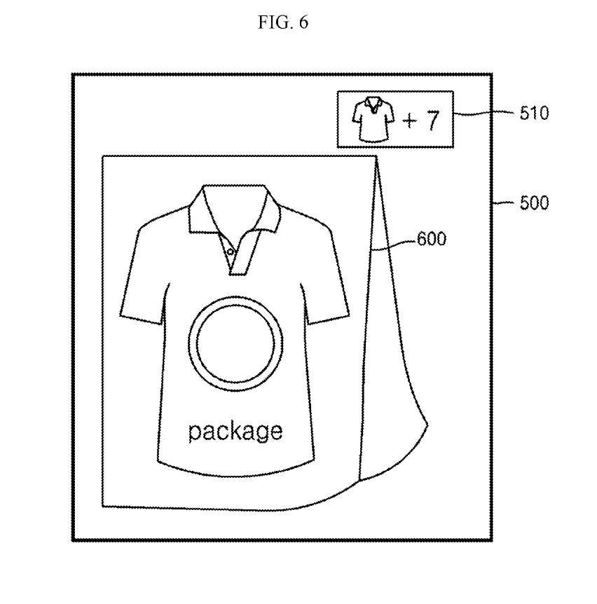

FIG. 6 shows a package set provided by packaging a player card in accordance with the present exemplary embodiment. The package set 500 may correspond to an item on the soccer game provided by the game server 200 shown in FIG. 1.

Referring to FIG. 6, the package set 500 may include a player card set 600 and a number block 510. The game server 200 may display the package set 500 on a screen of the user terminal 100, and a user of the user terminal 100 who wants buy the package set 500 may request the game server 200 to work on the purchase of the package set 500.

The number block 510 included in the package set 500 indicates the number of player cards included in the player card set 600. For example, as shown in FIG. 6, 7 player cards are included in the package set 500. The user terminal 100 which buys the package set 500 may perform the soccer game by using soccer player characters of the 7 player cards included in the package set 500.

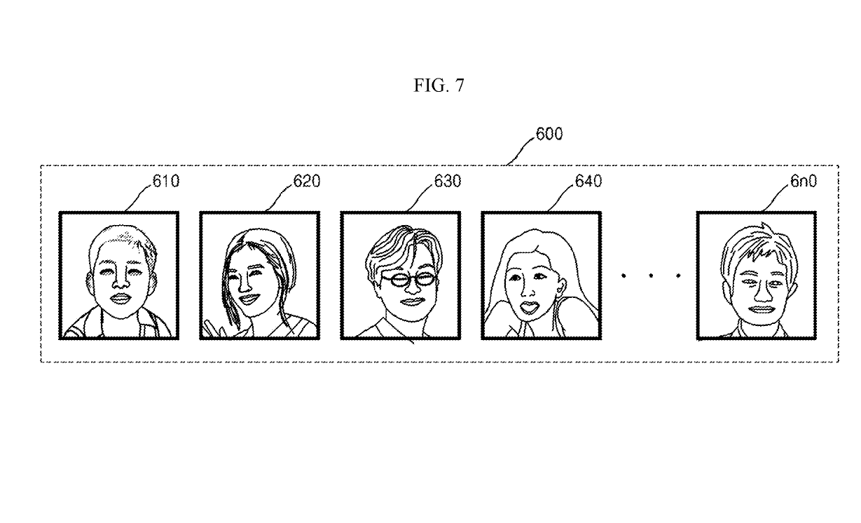

FIG. 7 shows player cards included in the package set in accordance with the present exemplary embodiment. An example of the player card set of FIG. 6 is shown in FIG. 7. Although the player card set 600 has been described to include a total of 7 player cards in FIG. 6, the player card set 600 is assumed to include a total of n player cards in FIG. 7.

Referring to FIG. 7, the player card set 600 includes n player cards 610, 620, 630, 640, . . . , and 6n0. The n player cards include different player cards, and the user terminal 100 which buys the player card set 600 may perform the soccer game by using the soccer player characters of the player cards included therein.

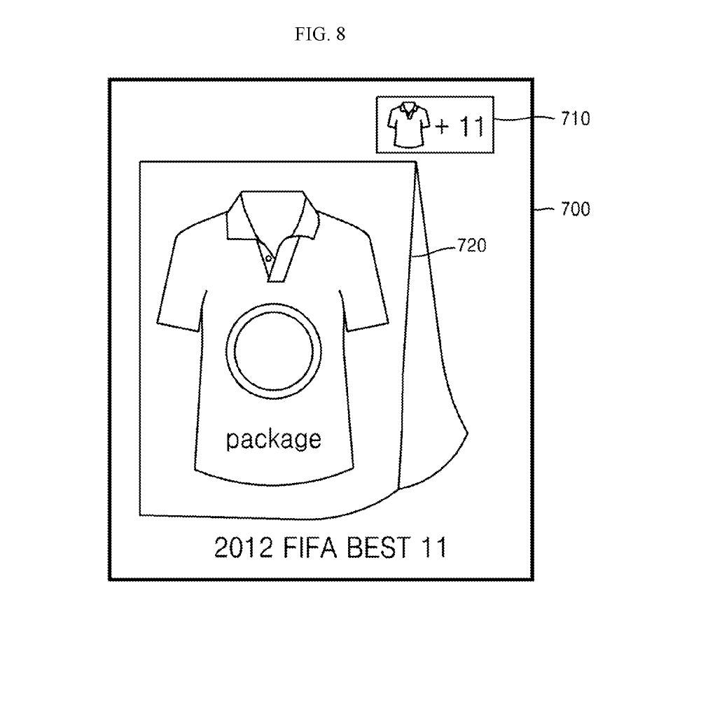

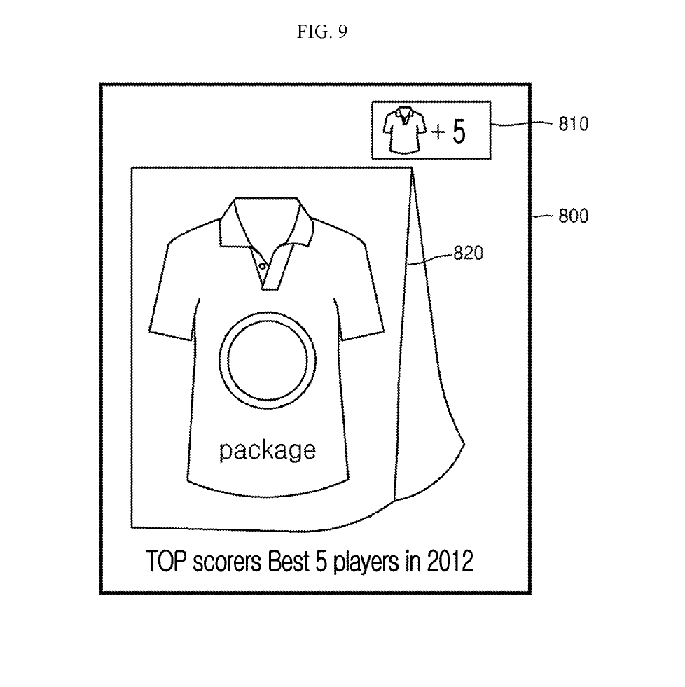

FIG. 8 and FIG. 9 show package sets reflected with information generated from the reality in accordance with other exemplary embodiments of the present invention. Examples of player card package items reflected with issues generated in the reality by the game item service system 10 of FIG. 1 are shown in FIG. 8 and FIG. 9.

A package set 700 of FIG. 8 includes a player card set 720 that is formed by packaging characters of FIFA 11 best soccer players in 2012. In this case, a number block 710 of the package set 700 indicates 11, and thus it is recognized that the player card set 720 includes a total of 11 player cards.

A package set 800 of FIG. 9 includes a player card set 820 that is formed by packaging characters of 5 Top scorer soccer players in 2012. In this case, a number block 810 of the package set 800 indicates 5, and thus it is recognized that the player card set 820 includes a total of 8 player cards.

In accordance with the exemplary embodiments of the present invention, it is possible to provide an effect of enabling a user to feel a sense of reality in a game by providing game items through reflection of real issues, thereby increasing an interest rate of the user in the game.

In addition, it is possible to facilitate improvement in sales of game items by continuously reflecting new issues generated in the reality.

The game item service method in accordance with the exemplary embodiments of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services

In this respect, the method for managing an item lottery service in accordance with the exemplary embodiments of the present invention may be implemented by the applications (i.e., programs) which are basically installed or directly installed by the user in the terminal and may be recorded in a computer readable recording medium of the terminal, and the like.

The programs are recorded in the computer readable recording medium and are executed by the computer, such that the above-mentioned functions may be executed.

As described above, in order for the computer to read the programs recorded in the recording medium and execute the method for managing an item lottery service in accordance with the exemplary embodiments of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions and may also include an execution procedure related control code required for the processor of the computer to execute the above-mentioned functions according to a predetermined procedure.

Further, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the game item service method in accordance with the exemplary embodiments of the present invention, may be a storage medium (for example, hard disk, and the like) included in an application store server or an application providing server such as a web server associated with applications or corresponding services, and the like, or the application providing server itself

A computer, which may read a recording medium recorded with applications that are programs for executing the game item service method in accordance with the exemplary embodiments of the present invention, may include not only a general PC such as a typical desktop and a laptop but also a mobile terminal such as a smart phone, a tablet PC, personal digital assistants (PDAs), and a mobile communication terminal, and is to be construed as all the computable devices

When a computer, which may read a recording medium recorded with applications that are programs for executing the game item service method in accordance with the exemplary embodiments of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention.

In addition, although each of all the components may be implemented by one independent hardware, some or all of the respective components which are selectively combined with each other may be implemented by a computer program having a program module performing some or all of functions combined with each other in one or plural hardware. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary and therefore, do not preclude other components but further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been just exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

1. A game item service method comprising:
by a game server,
receiving real issue data related to a game that is provided by the game server, from the outside; and
reflecting and applying the real issue data to an item.

2. The game item service method of claim 1, wherein the receiving includes receiving the real issue data by using information inputted from a manager who manages the game server.

3. The game item service method of claim 1, wherein the receiving includes receiving the real issue data by using information provided from a user terminal which accesses the game server to perform the game.

4. The game item service method of claim 1, wherein the applying includes applying the real issue data to a plurality of items and packaging the game items.

5. The game item service method of claim 4, wherein the packaging includes determining the number of items to be packaged to correspond to the real issue data by applying the real issue data and packaging the game items according to the determined number.

6. The game item service method of claim 1, wherein the game is a soccer game, and
the applying the real issue data to an item includes:
configuring player cards as an item having soccer player characters by reflecting the real issue data to the player cards and packaging the player cards; and
providing the packaged player cards to be bought on the game by a game user.

7. The game item service method of claim 6, wherein the configuring includes applying real issue data to the player cards on the game and packaging the player cards.

8. The game item service method of claim 7, wherein the packaging includes determining the number of player cards to be packaged to correspond to the real issue data by applying the real issue data and packaging the player cards on the game according to the determined number.

9. A game server comprising:
a transceiving module configured to transmit and receive data including a game item to and from a user terminal;
an issue managing module configured to manage real issue data related to a game provided by the game server, inputted from the outside; and
an item managing module configured to reflect and apply the real issue data to the game item to manage the item.

10. The game server of claim 9, wherein the item managing module includes:
an issue reflecting module configured to reflect and apply the real issue data provided from the issue managing module to the item to manage the item; and
a packaging module configured to reflect the real issue data to a plurality of items and package the items.

11. The game server of claim 9, wherein the game provided by the game server is a soccer game,
the item is player cards of soccer player characters, and
the game server further includes a player card managing module configured to manage the player cards in a package form.

12. The game server of claim 11, wherein the packaging module determines the number of the player cards to be packaged to correspond to the real issue data by applying the real issue data and packages the player cards on the game according to the determined number.

13. The game server of claim 9, further comprising
a payment module configured to perform cost management of a payment for an item managed by the item managing module, when a request of the payment is received from the user terminal.

14. A computer readable recording medium recorded with a program for executing a game item service method,
wherein the game item service method includes:
by a game server,
receiving real issue data related to a game that is provided by the game server, from the outside; and
reflecting and applying the real issue data to an item.

15. The recording medium of claim 14, wherein the game is a soccer game, and
the applying the real issue data to an item includes:
configuring player cards as an item having soccer player characters by reflecting the real issue data to the player cards and packaging the player cards; and
providing the packaged player cards to be bought on the game by a game user.
